(19) United States
(12) Patent Application Publication
(10) Pub. No.: US 2026/0012987 A1
(43) Pub. Date: Jan. 8, 2026

(54) COMMUNICATION APPARATUS, CONTROL METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: TOKIKO WATANABE, Tokyo (JP)

(21) Appl. No.: 19/250,309

(22) Filed: Jun. 26, 2025

(30) Foreign Application Priority Data
Jul. 3, 2024 (JP) 2024-107639

(51) Int. Cl. H04W 76/11; H04W 48/16

(52) U.S. Cl. CPC H04W 76/11; H04W 48/16

(57) ABSTRACT

A communication apparatus includes: a first execution unit that executes, based on the reception of the information used to connect to the first access point, a first setting for inhibiting the communication apparatus from executing change processing of changing a connection destination of the communication apparatus from the first access point to a second access point in response to a change request transmitted from the first access point; and a second execution unit that executes, based on performing of communication with the terminal device via the first access point, a second setting for allowing the communication apparatus to execute the change processing after the connection between the communication apparatus and the first access point is established.

### BACKGROUND

### Field of the Technology

The present disclosure relates to a communication apparatus connectable by a wireless LAN, a control method, and a non-transitory computer-readable storage medium storing a program.

### Description of the Related Art

There is a technique of dynamically switching a connection destination AP in order to efficiently exchange data between an Access Point (AP) and a Station (STA) in an Extended Service Set (ESS) constituted by a plurality of APs. If it is determined to switch the connection destination AP based on the degree of congestion of an AP to which an STA connects, the availability of other APs, the radio wave status, and the like, the connected AP transmits a connection destination AP change request to the STA. Upon receiving the connection destination AP change request, the STA can switch the connection destination AP in accordance with the request and connect to a proper AP.

Japanese Patent Laid-Open No. 2021-175068 discloses the following processing as processing of requesting change of a connection destination from a router having an AP function, of a connected wireless slave terminal. A mobile router (MR1) connectable to a plurality of wireless slave terminals checks whether a wireless slave terminal complies with IEEE 802.11v. Whether a wireless slave terminal complies with IEEE 802.11v can be determined from an Association Request frame transmitted when the wireless slave terminal wirelessly connects to the MR1. When the wireless slave terminal complies with IEEE 802.11v, the MR1 transmits a BSS Transition Management (BTM) Request frame to the wireless slave terminal. The BSS Transition Candidate List Entries field of the BTM Request frame designates the BSSID of a master router RT2 as a connection destination. This prompts switching of the connection destination of the wireless slave terminal, and the wireless slave terminal switches the connection destination from the MR1 to the RT2 in accordance with the received BTM Request frame.

### SUMMARY

The present disclosure provides a communication apparatus that controls execution possibility of a function of changing a connection destination AP, a control method, and a non-transitory computer-readable storage medium storing a program.

The present disclosure in one aspect provides a communication apparatus comprising at least one memory and at least one processor which function as: a reception unit configured to receive information used to connect to a first access point from a terminal device; a first establishment unit configured to establish connection between the communication apparatus and the first access point based on reception of the information used to connect to the first access point from the terminal device; a first execution unit configured to execute, based on the reception of the information used to connect to the first access point, a first setting for inhibiting the communication apparatus from executing change processing of changing a connection destination of the communication apparatus from the first access point to a second access point in response to a change request transmitted from the first access point; and a second execution unit configured to execute, based on performing of communication with the terminal device via the first access point, a second setting for allowing the communication apparatus to execute the change processing after the connection between the communication apparatus and the first access point is established.

Features of the present disclosure will become apparent from the following description of embodiments with reference to the attached drawings. The following description of embodiments are described by way of example.

### BRIEF DESCRIPTION OF THE DRAWINGS

FIG. 1 is a view showing a system configuration;

FIGS. 2A and 2B are views showing the configuration of a MFP;

FIGS. 3A to 3C are views showing the operation display unit of the MFP;

FIGS. 4A and 4B are views showing the configuration of a mobile terminal device;

FIG. 5 is a block diagram showing the configuration of an access point;

FIG. 6 is a sequence chart for explaining processing corresponding to a connection destination change request from an AP;

FIG. 7 is a view showing a function setting screen;

FIG. 8 is a view showing connection processing to an AP;

FIGS. 9A and 9B are flowcharts showing processing in the MFP;

FIGS. 10A and 10B are flowcharts showing processing in the mobile terminal device; and

FIG. 11 is a view showing a function setting screen in a setup application.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made a disclosure that requires all such features, and multiple such features may be combined as appropriate. Furthermore, in the attached drawings, the same reference numerals are given to the same or similar configurations, and redundant description thereof is omitted.

Concerning an STA, there are a case where no problem occurs in operation even if a connection destination AP is changed and a case where a problem occurs in operation if a connection destination AP is changed or the STA is disconnected from the connected AP.

According to the present disclosure, it is possible to control execution possibility of a function of changing a connection destination AP.

### (System Configuration)

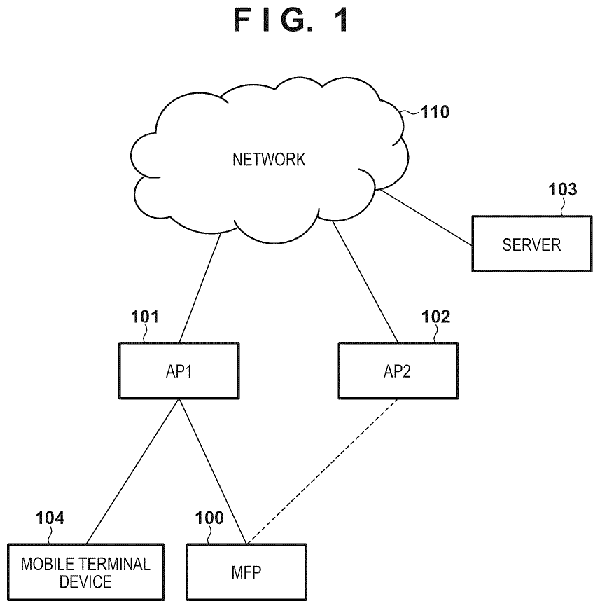

FIG. 1 shows an example of the configuration of a system according to the embodiment. In an example, the system is a wireless communication system in which a plurality of communication apparatuses can communicate with each other wirelessly. In the example of FIG. 1, the system includes a mobile terminal device 104 and an MFP 100 as communication apparatuses, APs 101 and 102 as access points (to be referred to as APs hereinafter), a server 103, and a network 110. Note that the APs 101 and 102 are sometimes referred to as AP1 and AP2. More specifically, the APs 101 and 102 are, for example, wireless LAN routers. Also, the APs 101 and 102 may be different APs validated by different wireless LAN routers, or may be different APs validated by one wireless LAN router and using different frequency bands. The mobile terminal device 104 is a device having a wireless communication function by a wireless LAN or the like. Note that the wireless LAN is sometimes referred to as WLAN hereinafter. The mobile terminal device 104 can be a personal information terminal such as a Personal Digital Assistant (PDA), a mobile phone (smartphone), a digital camera, a personal computer, or the like. In this embodiment, connection between the mobile terminal device 104 and an AP or connection between the MFP 100 and an AP is connection by a communication method based on the IEEE 802.11 series standard. More specifically, the communication method based on the IEEE 802.11 series standard is Wi-Fi (Wireless Fidelity)®.

The MFP 100 is a printing apparatus having a printing function or an image forming apparatus, and may further have a reading function (scanner), a facsimile (FAX) function, and a telephone function. The MFP 100 according to the embodiment has a communication function capable of wirelessly communicating with the mobile terminal device 104. A case where the MFP 100 is used will be exemplified in the embodiment, but the present disclosure is not limited to this. For example, a scanner, a projector, a mobile terminal, a smartphone, a notebook PC, a tablet terminal, a PDA, a digital camera, a music player, a television, or a smart speaker having a communication function may be used instead of the MFP 100. Note that the MFP is an acronym for Multi Function Peripheral.

The AP 101 is provided separately from (outside) the mobile terminal device 104 and the MFP 100, and operates as a WLAN base station apparatus. A communication apparatus having a WLAN communication function can communicate via the AP 101. Note that the access point is sometimes referred to as “AP” hereinafter. Also, a mode in which communication is performed via the AP 101 is sometimes referred to as “infrastructure connection mode”. The AP 101 performs wireless communication with a communication apparatus for which the AP 101 permits (authenticates) connection to the AP 101, and relays wireless communication between the communication apparatus and another communication apparatus. The AP 101 is connected to, for example, a wired communication network, and can relay communication between a communication apparatus connected to the wired communication network and another communication apparatus wirelessly connected to the AP 101.

The AP 102 has a function equivalent to that of the AP 101, and the MFP 100 switches (changes) the connection from the AP 101 to the AP 102, as needed. The server 103 connects to the MFP 100 via the AP 101 and the network 110, and provides services to the MFP 100 in response to a request from the MFP 100. The network 110 may be the so-called Internet, or a closed office network or a mobile phone network. The system according to this embodiment is not limited to the configuration shown in FIG. 1, and may include, for example, an authentication server that performs the above-described authentication.

### (Outer Appearance Configuration of MFP)

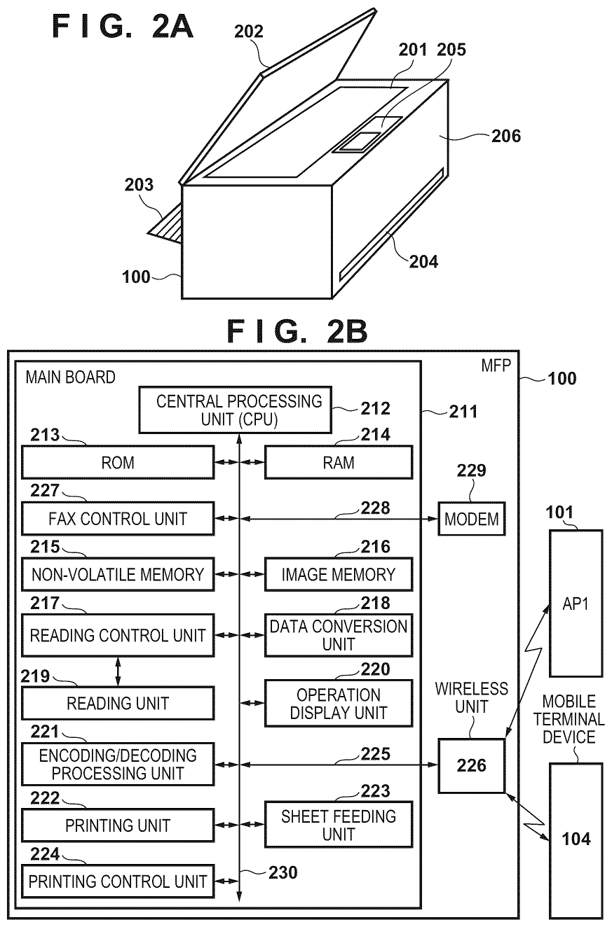

FIG. 2A shows an example of the outer appearance configuration of the MFP 100. The MFP 100 includes, for example, a document table 201, a document cover 202, a print sheet insertion port 203, a print sheet discharge port 204, and an operation display unit 205. The document table 201 is a table on which a document to be read is placed. The document cover 202 is a cover that presses a document on the document table 201 and prevents outward leakage of light from a light source irradiating the document at the time of reading. The print sheet insertion port 203 is an insertion port capable of setting sheets of various sizes. The print sheet discharge port 204 is a discharge port from which a sheet upon printing is discharged. Sheets set at the print sheet insertion port 203 are conveyed one by one to a printing unit, and after printing by the printing unit, discharged from the print sheet discharge port 204. The operation display unit 205 includes keys such as character input keys, cursor keys, an OK key, and a cancel key, an LED, and an LCD. The operation display unit 205 can accept activation of various functions of the MFP and operation of various settings by the user. The operation display unit 205 may include a touch panel display. The MFP 100 has a WLAN wireless communication function, and includes a wireless communication antenna 206 for the wireless communication that need not always be visible from the outer appearance. Similar to the mobile terminal device 104, the MFP 100 can perform wireless communication in the 2.4- and 5-GHz frequency bands by the WLAN.

### (Configuration of MFP)

FIG. 2B shows an example of the configuration of the MFP 100. The MFP 100 includes a main board 211 that performs main control of the MFP 100, and a wireless unit 226 serving as one communication module (communication interface) that performs WLAN communication using at least one common antenna. The MFP 100 includes a modem 229 for performing, for example, wired communication. The main board 211 includes, for example, a central processing unit (CPU) 212, a ROM 213, a RAM 214, a nonvolatile memory 215, an image memory 216, a reading control unit 217, a data conversion unit 218, a reading unit 219, and an encoding/decoding processing unit 221. The main board 211 includes, for example, a printing unit 222, a sheet feeding unit 223, a printing control unit 224, and an operation display unit 220. The functional units in the main board 211 are connected to each other via a system bus 230 managed by the CPU 212. The main board 211 and the wireless unit 226 are connected via, for example, a dedicated bus 225, and the main board 211 and the modem 229 are connected via, for example, a bus 228.

The CPU 212 is a system control unit including at least one processor, and controls the MFP 100 overall. In an example, processing of the MFP 100 to be described below is implemented by executing a program stored in the ROM 213 by the CPU 212. Note that hardware dedicated to each processing may be prepared. The ROM 213 is an example of a computer-readable storage medium that stores control programs to be executed by the CPU 212, an embedded OS program, and the like. Note that the OS is an operating system. In the embodiment, the CPU 212 executes each control program stored in the ROM 213 under the management of the embedded OS similarly stored in the ROM 213, thereby performing software control such as scheduling or task switching.

The RAM 214 is constituted by a SRAM or the like. The RAM 214 stores data such as program control variables, and data such as set values registered by the user and management data of the MFP 100. The RAM 214 can be used as a buffer for various work. The nonvolatile memory 215 is constituted by a memory such as a flash memory, and keeps storing data even after the MFP 100 is turned off. The image memory 216 is constituted by a memory such as a DRAM. The image memory 216 accumulates image data received via the wireless unit 226, image data processed by the encoding/decoding processing unit 221, and the like. Note that the memory configuration of the MFP 100 is not limited to the above-described one. The data conversion unit 218 performs analysis of data of various forms, conversion from image data into print data, and the like.

The reading control unit 217 controls the reading unit 219 (for example, a contact image sensor (CIS)) to optically read a document on the document table 201. The reading control unit 217 converts an image obtained by optically reading the document into electrical image data (image signal), and outputs the image data. At this time, the reading control unit 217 may output image data after performing various image processes such as binarization processing and halftone processing.

The operation display unit 220 is the operation display unit 205 described with reference to FIG. 2A, and executes display on a display based on display control by the CPU 212, generation of a signal in response to acceptance of a user operation, and the like.

The encoding/decoding processing unit 221 performs encoding processing, decoding processing, and scaling processing on image data (JPEG, PNG, and the like) handled by the MFP 100.

The sheet feeding unit 223 holds sheets for printing. The sheet feeding unit 223 can supply a set sheet under the control of the printing control unit 224. The sheet feeding unit 223 may include a plurality of sheet feeding units in order to hold sheets of a plurality of types, and can control which sheet feeding unit feeds a sheet under the control of the printing control unit 224.

The printing control unit 224 performs various image processes such as smoothing processing, print density correction processing, and color correction on image data to be printed, and outputs the processed image data to the printing unit 222. The printing unit 222 is constituted to be able to execute printing processing by, for example, the inkjet method. The printing unit 222 discharges, from a printhead, ink supplied from an ink tank, and prints an image on a print medium such as a sheet. Note that the printing unit 222 may be constituted to be able to execute another printing processing by the electrophotographic method or the like. The printing control unit 224 can periodically read out information of the printing unit 222, and update status information and the like that are stored in the RAM 214 and include the remaining ink amount of the ink tank, the state of the printhead, and the like.

The wireless unit 226 is a unit capable of providing the WLAN communication function, and can provide, for example, the same function as that of a WLAN unit 429 of the mobile terminal device 104. That is, the wireless unit 226 converts data into a packet in accordance with the WLAN standard, and transmits the packet to another device. In addition, the wireless unit 226 restores original data from a packet from another external device, and outputs the data to the CPU 212. The wireless unit 226 can communicate as a station compliant with the IEEE 802.11 standard series. In particular, the wireless unit 226 can communicate as a station compliant with IEEE 802.11a/b/g/n/ac/ax. The station is sometimes referred to as a STA hereinafter. The wireless unit 226 can also communicate as a STA compliant with Wi-Fi Agile Multiband™.

The wireless unit 226 complies with IEEE 802.11ax, that is, Wi-Fi 6®, and the MFP 100 can operate as an STA supporting (compliant with) at least one of OFDMA and TWT. Here, the OFDMA is an acronym for Orthogonal Frequency-Division Multiple Access. The TWT is an acronym for Target Wake Time. Since the MFP 100 complies with TWT, the timing of data communication from a master device to a STA is adjusted. The wireless unit 226 (MFP 100) as the STA shifts the communication function to a sleep state when it need not wait for signal reception. This can suppress power consumption. The wireless unit 226 also complies with Wi-Fi 6E®. That is, the wireless unit 226 can communicate even in the 6-GHz band (5.925 GHz to 7.125 GHz). A target band present in the 5-GHz band in which Dynamic Frequency Selection (DFS) is performed does not exist in the 6-GHz band. In the 6-GHz band communication, therefore, a communication disconnection caused by the DFS standby time does not occur, and a more comfortable communication can be expected.

Note that the mobile terminal device 104 and the MFP 100 can perform WFD-based P2P (WLAN) communication, and the wireless unit 226 has a software access point (soft AP) function or a group owner function. That is, the wireless unit 226 can construct a P2P communication network and decide a channel used in P2P communication.

### (Operation Display Unit of MFP)

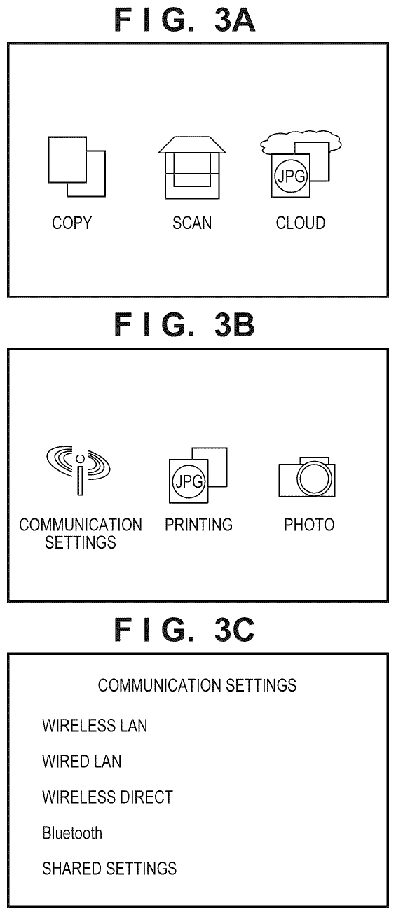

FIGS. 3A to 3C schematically show an example of screen display on a display (touch panel display) included in the operation display unit 220 of the MFP 100. FIG. 3A shows an example of a home screen displayed during a state (idle state or Standby state) in which the MFP 100 is turned on and an operation such as printing or scanning is not performed. In FIG. 3A, display items (menu items) corresponding to copy, scan, cloud are displayed. Cloud is a menu item regarding a cloud function using Internet communication. When any menu item is selected by a key operation or a touch panel operation, the MFP 100 can start executing a corresponding setting or function. The MFP 100 can seamlessly display a screen different from one in FIG. 3A by accepting a key operation or a touch panel operation on the home screen in FIG. 3A.

FIG. 3B shows a display example of another portion of the home screen. This screen is shifted from the state in FIG. 3A by an operation (for example, a slide operation to left or right) of displaying another page of the home screen. In FIG. 3B, display items (menu items) corresponding to communication setting, print, and photo are displayed. When any menu item is selected, a function corresponding to the selected menu item, that is, any of the printing function, photo function, and communication setting is executed.

FIG. 3C shows a display example of the menu screen of the communication setting displayed when the communication setting is selected on the screen in FIG. 3B. The menu screen of the communication setting displays menu items (choices) “wireless LAN”, “wired LAN”, “wireless direct”, “Bluetooth”, and “common”. “Wireless LAN”, “wired LAN”, and “wireless direct” are menu items for performing LAN setting. From these items, settings such as setting of wired connection, valid/invalid setting of the infrastructure connection mode, and valid/invalid setting of the direct connection mode such as WFD or soft AP mode can be performed. When the item “wireless LAN” is selected and the wireless LAN is set valid by a user operation, the infrastructure connection mode becomes valid. When the item “wireless direct” is selected and the wireless direct is set valid by a user operation, the direct connection mode becomes valid. When the item “common” is selected, a common setting menu regarding various connection forms is displayed. The user can perform setting of the frequency band and frequency channel of the wireless LAN, and the like.

### (Outer Appearance Configuration of Mobile Terminal Device)

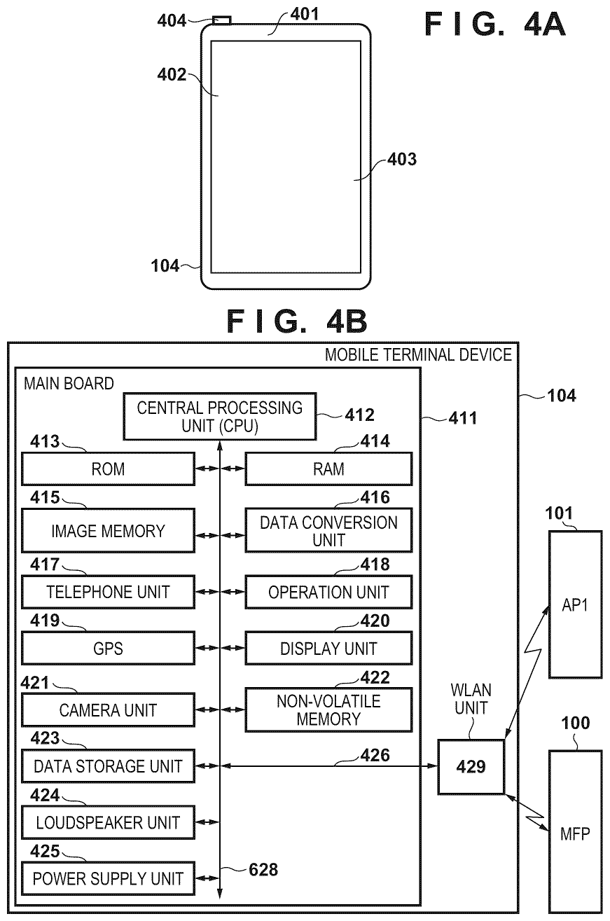

FIG. 4A is a view showing an example of the outer appearance configuration of the mobile terminal device 104. In the embodiment, a case where the mobile terminal device 104 is a smartphone of a general form will be exemplified. Note that the mobile terminal device 104 includes, for example, a display unit 402, an operation unit 403, and a power key 404. The display unit 402 is, for example, a display including a Liquid Crystal Display (LCD) type display mechanism. Note that the display unit 402 may display information using a Light Emitting Diode (LED) or the like. The mobile terminal device 104 may have a function of outputting information by sound, in addition to or instead of the display unit 402. The operation unit 403 includes physical keys such as keys and buttons, a touch panel, and the like for detecting a user operation. Note that in this example, information display on the display unit 402 and acceptance of a user operation by the operation unit 403 are performed using a common touch panel display, and the display unit 402 and the operation unit 403 are implemented by one device. In this case, for example, button icons and a software keyboard are displayed using the display function of the display unit 402, and touches of these portions by the user are detected by the operation acceptance function of the operation unit 403. Note that it is also possible to separate the display unit 402 and the operation unit 403, and separately prepare display hardware and operation acceptance hardware. The power key 404 is a physical key for accepting a user operation of turning on or off the mobile terminal device 104.

The mobile terminal device 104 includes a WLAN unit 401 that provides the WLAN communication function though it need not always be visible from the outer appearance. The WLAN unit 401 is constituted to be able to execute data (packet) communication in a WLAN system compliant with, for example, the IEEE 802.11 standard series (for example, IEEE 802.11a/b/g/n/ac/ax). The WLAN unit 401 can communicate as an AP compliant with Wi-Fi Agile Multiband®. However, the WLAN unit 401 is not limited to this, and may be able to execute communication of a WLAN system compliant with another standard. Note that this example assumes that the WLAN unit 401 can communicate in both the 2.4- and 5-GHz frequency bands. Also, the WLAN unit 401 can execute WFD-based communication, communication in the soft AP mode, communication in the infrastructure connection mode, and the like. Operations in these modes will be described later.

### (Configuration of Mobile Terminal Device)

FIG. 4B shows an example of the configuration of the mobile terminal device 104. In an example, the mobile terminal device 104 includes a main board 411 that performs main control of the mobile terminal device 104, and the WLAN unit 429 that performs WLAN communication. The main board 411 includes, for example, a CPU 412, a ROM 413, a RAM 414, an image memory 415, a data conversion unit 416, a telephone unit 417, a GPS 419, a camera unit 421, a nonvolatile memory 422, a data accumulation unit 423, a loudspeaker unit 424, and a power supply unit 425. The CPU is an acronym for Central Processing Unit, the ROM is an acronym for Read Only Memory, the RAM is an acronym for Random Access Memory, and the GPS is an acronym for Global Positioning System. The mobile terminal device 104 also includes a display unit 420 and an operation unit 418. The functional units in the main board 411 are connected to each other via a system bus 628 managed by the CPU 412. The main board 411 and the WLAN unit 429 are connected via, for example, a dedicated bus 426.

The CPU 412 is a system control unit including at least one processor, and controls the mobile terminal device 104 overall. In an example, processing of the mobile terminal device 104 to be described below is implemented by executing a program stored in the ROM 413 by the CPU 412. Note that hardware dedicated to each processing may be prepared. The ROM 413 stores control programs to be executed by the CPU 412, an embedded operating system (OS) program, and the like. In the embodiment, the CPU 412 executes each control program stored in the ROM 413 under the management of the embedded OS similarly stored in the ROM 413, thereby performing software control such as scheduling or task switching.

The RAM 414 is constituted by a Static RAM (SRAM) or the like. The RAM 414 stores data such as program control variables, and data such as set values registered by the user and management data of the mobile terminal device 104. The RAM 414 can be used as a buffer for various work. The image memory 415 is constituted by a memory such as a Dynamic RAM (DRAM). The image memory 415 temporarily stores image data received via the WLAN unit 429, and image data read out from the data accumulation unit 423, in order to process the data by the CPU 412. The nonvolatile memory 422 is constituted by a memory such as a flash memory, and keeps storing data even after the mobile terminal device 104 is turned off. Note that the memory configuration of the mobile terminal device 104 is not limited to the above-described one. For example, the image memory 415 and the RAM 414 may be shared, or the data accumulation unit 423 may be used to perform backup of data or the like. The DRAM is exemplified as the image memory 415 in the embodiment, but another storage medium such as a hard disk or a nonvolatile memory may be used.

The data conversion unit 416 performs analysis of data of various forms, and data conversion such as color conversion or image conversion. The telephone unit 417 controls a telephone line, and processes audio data input/output via the loudspeaker unit 424, thereby implementing telephone communication. The GPS 419 receives radio waves sent from a satellite and obtains position information such as the current latitude and longitude of the mobile terminal device 104.

The camera unit 421 has a function of electronically recording an image input via a lens and encoding it. Image data obtained by image capturing by the camera unit 421 is saved in the data accumulation unit 423. The loudspeaker unit 424 performs control for implementing a function of inputting or outputting voice for the telephone function, and a function such as alarm notification. The power supply unit 425 is, for example, a portable battery and performs power supply control into the device. The power supply state includes, for example, a battery exhaustion state in which the battery runs out, a power off state in which the power key 404 is not pressed, an active state in which the mobile terminal device 104 is normally activated, and a power saving state in which the mobile terminal device 104 is activated but power is saved.

The display unit 420 is the display unit 402 described with reference to FIG. 4A, and displays various input operations, the operation state of the MFP 100, the status state, and the like based on the control of the CPU 412. The operation unit 418 is the operation unit 403 described with reference to FIG. 4A, and executes control of, upon accepting a user operation, generating an electrical signal corresponding to the operation and outputting it to the CPU 412.

The mobile terminal device 104 performs wireless communication with the WLAN unit 429, and performs data communication with another device such as the MFP 100. The WLAN unit 429 converts data into a packet, and transmits the packet to another device. In addition, the WLAN unit 429 restores original data from a packet from another external device, and outputs the data to the CPU 412. The WLAN unit 429 is a unit for implementing communication compliant with the WLAN standard. The WLAN unit 429 can operate concurrently in at least two connection modes including the infrastructure connection mode and the direct connection mode. Note that frequency bands used in these connection modes can be restricted by the hardware functions and performance.

### (Configuration of Access Point)

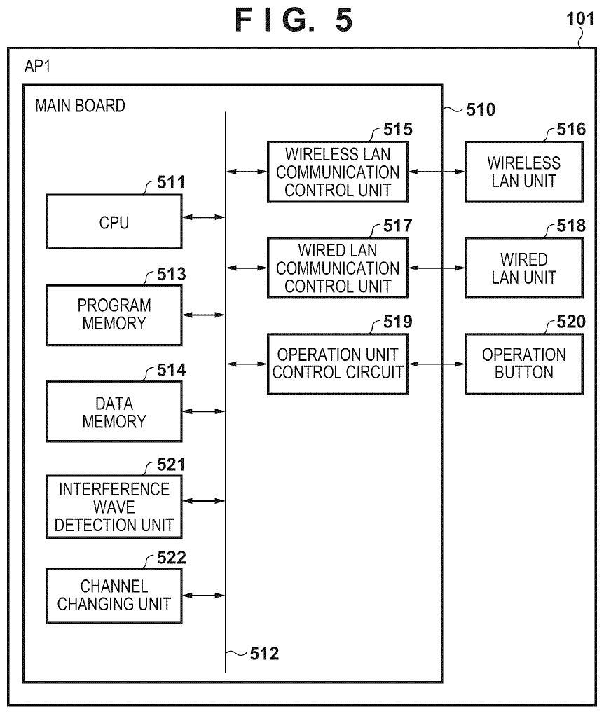

FIG. 5 is a block diagram showing the configuration of the AP 101 having a wireless LAN access point function. The AP 101 includes a main board 510 that controls the AP 101, a wireless LAN unit 516, a wired LAN unit 518, and an operation button 520.

A CPU 511 in the form of a microprocessor arranged on the main board 510 operates in accordance with a control program stored in a program memory 513 in the form of a ROM connected via an internal bus 512, and the contents of a data memory 514 in the form of a RAM. The CPU 511 performs wireless LAN communication with another communication terminal apparatus by controlling the wireless LAN unit 516 via a wireless LAN communication control unit 515. The CPU 511 performs wired LAN communication with another communication terminal apparatus by controlling the wired LAN unit 518 via a wired LAN communication control unit 517. The CPU 511 can accept an operation from the user via the operation button 520 by controlling an operation unit control circuit 519. The CPU 511 includes at least one processor.

The AP 101 also includes an interference wave detection unit 521 and a channel change unit 522. The interference wave detection unit 521 performs interference wave detection processing when wireless communication is executed in a band in which Dynamic Frequency Selection (DFS) is executed. When an interference wave is detected while wireless communication is executed in the band in which DFS is executed, the channel change unit 522 performs change processing of a channel used in a case where the channel has to be immediately changed to a free channel. Note that the AP 102 also has a configuration similar to that of the AP 101.

### <Direct Connection Method>

Direct connection is a form in which devices are wirelessly connected directly (that is, Peer to Peer) without interposing an external device such as the AP 101. Direct connection is also called Peer to Peer connection (P2P connection). The MFP 100 can operate in a mode (direct connection mode) for communicating by direct connection as one of connection modes. In Wi-Fi communication, there exist a plurality of modes for communicating by direct connection, like a software AP mode and a Wi-Fi Direct (WFD) mode.

A mode in which direct connection is executed by WFD is called a WFD mode. WFD is a standard formulated by the Wi-Fi Alliance and included in the communication standards of IEEE 802.11 series. In the WFD mode, a device that is a communication partner is searched for by a device search command, the roles of the group owner (GO) of P2P and the client of P2P are decided, and the rest of wireless connection processing is performed. The group owner corresponds to the master station (master device) of Wi-Fi, and the client corresponds to a slave station (slave device) of Wi-Fi. This role decision corresponds to, for example, GO Negotiation in P2P. Note that in the WFD mode before the role decision is performed, the MFP 100 is neither a master station nor a slave station. More specifically, one of devices to perform communication issues a device search command and searches for a device to be connected in the WFD mode. If another device as a communication partner is discovered, both devices confirm information about services and functions that can be supplied between these. Note that the device supply information confirmation is optional and not essential. The device supply information conformation phase corresponds to, for example, Provision Discovery in P2P.

Next, each other's device supply information is confirmed to decide the roles, that is, which device should be the client of P2P and which should be the group owner of P2P. Next, when the client and the group owner are decided, parameters used to perform communication by WFD are exchanged between the devices. Based on the exchanged parameters, the rest of wireless connection processing and IP connection processing are performed between the client and the group owner of P2P. Note that in the WFD mode, the MFP 100 may always operate as GO without executing the above-described GO Negotiation. That is, the MFP 100 may operate in a WFD mode as an Autonomous GO mode. A state in which the MFP 100 operates in the WFD mode is, for example, a state in which connection by WFD is not established, but the MFP 100 operates as the GO or a state in which connection by WFD is established, and the MFP 100 operates as the GO.

In the software AP mode, one (for example, the mobile terminal device 104) of devices to perform communication (for example, the mobile terminal device 104 and the MFP 100) is the client that plays the role of requesting various kinds of services. The other device implements the function of an AP in Wi-Fi by software setting. The software AP corresponds to the master station of Wi-Fi, and the client corresponds to a slave station of Wi-Fi. In the software AP mode, the client searches for a device as a software AP by a device search command. If a software AP is discovered, the rest of wireless connection processing (establishment of wireless connection, and the like) is performed between the client and the software AP and, after that, IP connection processing (IP address assignment, and the like) is performed. Note that as the commands and parameters transmitted/received when implementing wireless connection between the client and the software AP, those defined in the Wi-Fi standard are used, and a description thereof will be omitted here.

In this embodiment, in a case where the MFP 100 establishes/maintains direct connection, it operates as a master station in the network to which the MFP 100 belongs. Note that the master station is a device that constructs a wireless network and provides, to a slave station, parameters used for connection to the wireless network. The parameters used for connection to the wireless network are, for example, parameters concerning a channel used by the master station. The slave station receives the parameters, thereby connecting, using the channel used by the master station, to the wireless network constructed by the master station. In the direct connection mode, since the MFP 100 operates as the master station, the MFP 100 can decide which frequency and channel should be used for communication in the direct connection mode. In this embodiment, the MFP 100 can use a channel corresponding to a 2.4-GHz frequency band and a channel corresponding to a 5-GHz frequency band for communication in the direct connection mode.

### <Infrastructure Connection Mode>

Infrastructure connection is a connection form in which devices (for example, the mobile terminal device 104 and the MFP 100) to perform communication connect to an AP (for example, the AP 101) that controls the network of the devices, and the devices communicate via the AP. The MFP 100 can operate even in a mode (infrastructure connection mode) for communicating by infrastructure connection as one of connection modes.

In infrastructure connection, each device searches for an AP by a device search command. If an AP is discovered, the rest of wireless connection processing (establishment of wireless connection, and the like) is performed between the devices and the AP and, after that, IP connection processing (IP address assignment, and the like) is performed. Note that as the commands and parameters transmitted/received when implementing wireless connection between the devices and the AP, those defined in the Wi-Fi standard are used, and a description thereof will be omitted here.

In this embodiment, when the MFP 100 operates by infrastructure connection, the AP 101 operates as a master station, and the MFP 100 operates as a slave station. That is, in this embodiment, infrastructure connection indicates connection between the MFP 100 that operates as the slave station and the apparatus that operates as the master station. If the MFP 100 establishes infrastructure connection and the mobile terminal device 104 also establishes infrastructure connection with the AP 101, communication can be performed between the MFP 100 and the mobile terminal device 104 via the AP 101. Since the channel used for communication in the infrastructure connection is decided by the AP 101, the MFP 100 executes communication in the infrastructure connection using the channel decided by the AP 101. In this embodiment, the MFP 100 can use a channel corresponding to a 2.4-GHz frequency band and a channel corresponding to a 5-GHz frequency band for communication in the infrastructure connection. Note that the MFP 100 can use even a channel corresponding to a DFS band in the 5-GHz frequency band for communication in the infrastructure connection. Note that to communicate with the MFP 100 via the AP 101, the mobile terminal device 104 recognizes/specifies that the MFP 100 belongs to the network which is formed by the AP 101 and to which the mobile terminal device 104 belongs.

### (Wi-Fi Agile Multiband)

Wi-Fi Agile Multiband is a function complying with the IEEE 802.11v, IEEE 802.11r, and IEEE 802.11k standards and is a function for controlling such that a communication apparatus is connected to an appropriate network in accordance with the state of the network around the communication apparatus. This function is also referred to as a band steering function hereinafter.

In this embodiment, the mobile terminal device 104 and the MFP 100 support the function of Wi-Fi Agile Multiband® and can perform communication as an STA supporting Wi-Fi Agile Multiband. Also, the mobile terminal device 104 and the MFP 100 also support the function of Wi-Fi 6® that is a function complying with the IEEE 802.11ax standard. Thus, the mobile terminal device 104 and the MFP 100 can execute an operation as an STA supporting Orthogonal Frequency-Division Multiple Access (OFDMA) and Target Wake Time (TWT) as the function of Wi-Fi 6. The mobile terminal device 104 and the MFP 100 each serving as an STA can suppress power consumption by shifting the communication function to a sleep state when these need not wait for signal reception. Note that, more specifically, the mobile terminal device 104 and the MFP 100 may support the function of Wi-Fi 6E® as the function of Wi-Fi 6. That is, the mobile terminal device 104 and the MFP 100 may be able to perform communication in a 6-GHz band (5.925 GHz to 7.125 GHZ). A target band present in the 5-GHz band in which Dynamic Frequency Selection (DFS) is performed does not exist in the 6-GHz band. In the 6-GHz band communication, therefore, a communication disconnection caused by the DFS standby time does not occur. Note that as described above, in this embodiment, the mobile terminal device 104 and the MFP 100 support both Wi-Fi Agile Multiband and Wi-Fi 6, but the present disclosure is not limited to this form. For example, the mobile terminal device 104 and the MFP 100 may support Wi-Fi Agile Multiband but may not support Wi-Fi 6.

A wireless LAN router that enables the function enables a plurality of access points that use different frequency bands and sets the ESSIDs of the access points to the same name. The ESSID is an Extended Service Set Identifier. More specifically, for example, one router that enables the band steering function activates a first access point connectable in a first frequency band and a second access point connectable in a second frequency band. The first access point is, for example, the AP 101, and the second access point is, for example, the AP 102. In a state in which the MFP 100 is connected to the first access point, if the communication environment of the first frequency band is unstable, the wireless LAN router instructs the MFP 100 to switch (change) the connection destination to the second access point that forms a network of better communication environment which is a network using the second frequency band. The MFP 100 thus switches the connection destination AP to the second access point. Similarly, in a state in which the mobile terminal device 104 is connected to the first access point, if the communication environment of the first frequency band is unstable, the wireless LAN router instructs the mobile terminal device 104 to switch the connection destination AP to the second access point. The mobile terminal device 104 thus switches the connection destination AP to the second access point. Note that whether the communication environment is unstable or not is determined by the wireless LAN router based on a radio field intensity or a quantity of noise radio waves specified based on information the wireless LAN router receives from the MFP 100 or the mobile terminal device 104 or the number of devices connected to each access point enabled by the wireless LAN router. Thus, the mobile terminal device 104 or the MFP 100, which is the client supporting the band steering function, is connected to one of the plurality of access points and can then automatically switch the connection destination to another access point that uses a frequency band of better communication environment. That is, in this embodiment, the MFP 100 can use a plurality of frequency bands including the first frequency band and the second frequency band. One wireless LAN router that enables the band steering function activates the first access point connectable in the first frequency band and the second access point connectable in the second frequency band. The MFP 100 can use only one frequency band and need not execute connection destination switching based on the band steering function. Even in this form, the mobile terminal device 104 can execute connection destination switching based on the band steering function.

Note that connection destination switching by the band steering function can be executed only between access points having the same ESSID. That is, the first access point and the second access point have the same ESSID. However, the BSSID need not be the same between the first access point and the second access point.

Also, the first access point and the second access point are enabled in one wireless LAN router that enables the function, as described above, but the present disclosure is not limited to this form. The first access point and the second access point may separately be enabled in two wireless LAN routers that enable the function. Even in this form, however, the first access point and the second access point, which are the targets of connection destination switching based on the band steering function, have the same ESSID. Also, in this form, the wireless LAN router that enables the first access point instructs the mobile terminal device 104 to switch the connection destination to the second access point.

(Processing Corresponding to Connection Destination Change Request from AP to STA)

The mobile terminal device 104 and the MFP 100 support a function released to the public as Wi-Fi Agile Multiband®. Wi-Fi Agile Multiband is a function of enabling selection of an optimal environment in accordance with a situation in which a Wi-Fi network changes. More specifically, STAs such as the mobile terminal device 104 and the MFP 100, and APs such as the AP 101 exchange information about a network environment using the IEEE 802.11 series communication standard. By this information exchange, when a network is congested, the AP can induce (change the connection destination) the STA to another AP, frequency band, channel, or in some cases, another cellular service.

The communication standards of IEEE 802.11 series include IEEE 802.11k, IEEE 802.11v, and the like. IEEE 802.11k is a standard concerning a function called Dynamic Monitoring. This function notifies, from an AP to an STA, the position of each AP in the neighborhood, the strength of a beacon signal from each AP, the signal level of a wireless LAN in each channel, the signal level other than a wireless LAN in each channel, and the like. IEEE 802.11v is a standard concerning a function known as Wireless Network Management. This function provides a function of shifting communication of an STA to another AP or another frequency band/channel using a measurement result using IEEE 802.11k.

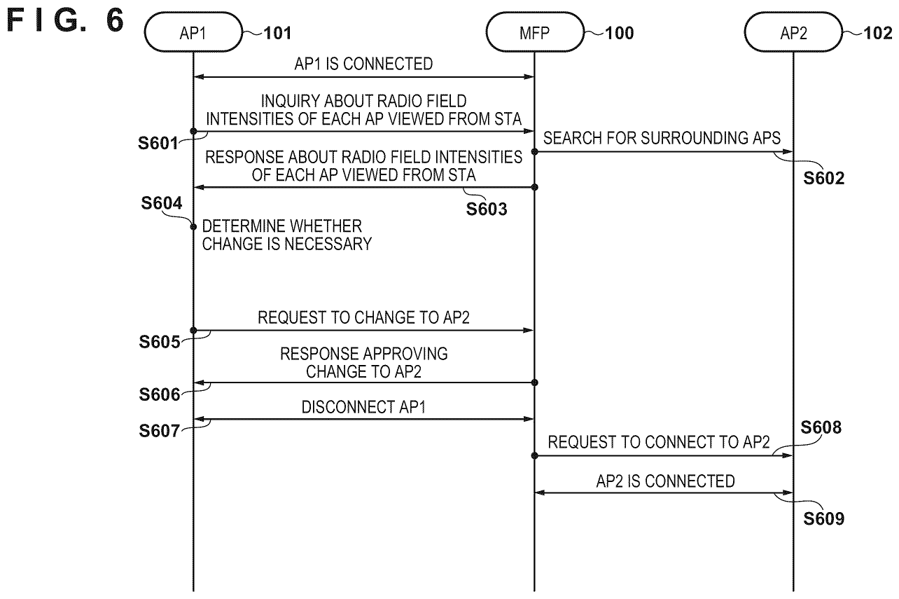

FIG. 6 is a sequence chart when the MFP 100 switches the connection destination AP from the AP 101 to the AP 102 in accordance with a connection destination AP change request from the AP 101. Processing executed by each apparatus in this sequence is implemented by reading out various programs stored in the memory of each apparatus such as a ROM to a RAM and executing them by the CPU of each apparatus.

In the initial state of the processing in FIG. 6, assume that the MFP 100 establishes connection with the AP 101 in the infrastructure connection mode. When the MFP 100 and the AP 101 connect to each other in the infrastructure connection mode, the AP 101 obtains information of whether the MFP 100 supports IEEE 802.11v. If the AP 101 obtains information representing that the MFP 100 supports IEEE 802.11v, the following processing is performed. The AP 101 determines, based on an Association Request frame transmitted when the MFP 100 wirelessly connects to the AP 101, whether the MFP 100 supports IEEE 802.11v.

In S601, the AP 101 transmits, to the MFP 100, an inquiry (measurement requests) about the radio field intensities of APs around the MFP 100. This inquiry can be transmitted including a beacon frame request or a beacon report request. That is, this request can use a mechanism defined by the IEEE 802.11k standard.

In S602, the MFP 100 receives frames transmitted from the surrounding APs in accordance with the request received in S601, and measures radio field intensities. Hence, the radio field intensities of the respective APs including the APs 101 and 102 are measured.

In S603, the MFP 100 transmits, as a response to the request received in S601, a list of the radio field intensities of the APs around the MFP 100 that are measured in S602. Note that the radio field intensity as a response may be information saved in the RAM 214 or nonvolatile memory 215 of the MFP 100, in addition to or instead of the information measured in S602. This response is transmitted including a Beacon Report or measurement reports.

In S604, the AP 101 determines, based on the congestion status within a network grasped by the AP 101 and the radio field intensities received from the MFP 100 in S603, whether the connection destination AP of the MFP 100 needs to be changed. Factors with which the AP 101 determines that the connection destination AP needs to be changed are, for example, many STAs connected to the AP 101, a large communication amount between the AP 101 and the STA connected to the AP 101, the presence/absence of an interference radio wave determined based on the SN ratio or the like, and the stop of the AP function. Alternatively, it may be determined, based on the degree of congestion (the number of connected STAs and the communication amount) of each AP, which is determined using communication between the APs, whether the connection destination AP needs to be changed. If it is determined that the connection destination AP of the MFP 100 needs to be changed, and the SSID, channel, and frequency band of another AP designated as the connection destination AP after the change are decided, the process advances to S605.

In S605, the AP 101 transmits a connection destination AP change request to the MFP 100. The connection destination AP change request includes information of the SSID, channel, and frequency band of another AP designated as the connection destination AP after the change, which are decided in S604. Note that a plurality of SSIDs may be designated. The connection destination AP change request is transmitted as, for example, a BTM Request. That is, a BSS Transition Management (BTM) Request frame defined by the IEEE 802.11v standard is transmitted. In the example of FIG. 6, assume that the AP 102 is designated as the connection destination AP after the change included in the connection destination AP change request.

In S606, if the MFP 100 complies with the connection destination AP change request received in S605, it transmits, to the AP 101, a response representing approval of switching (approval of change of the connection destination AP). If MFP 100 does not comply with the change connection destination AP request, it may transmit rejection of switching (rejection of change of the connection destination AP) as a response. The response is transmitted as a BTM Response. In the example of FIG. 6, assume that a response representing approval is transmitted.

In S607, the AP 101 and the MFP 100 disconnect connection in the infrastructure connection mode.

In S608, the MFP 100 transmits a connection request to the AP 102 so as to connect to the AP 102 designated by the connection destination AP change request received in S605.

In S609, therefore, connection between the MFP 100 and the AP 102 in the infrastructure connection mode is established.

With this mechanism, the MFP 100 serving as an STA can change the connection destination from the AP 101 to the AP 102 based on the connection destination AP change request from the originally connected AP 101. The APs 101 and 102 may be APs installed in different places. That is, by the processing of FIG. 6, the MFP 100 can switch to another AP installed at a position different from that of the originally connected AP. APs sometimes correspond to different frequency bands out of a plurality of frequency bands (two or three of 2.4-, 5-, and 6-GHz bands) provided by an identical device. That is, by the processing of FIG. 6, the MFP 100 can switch to another frequency band provided by an apparatus identical to the originally connected AP.

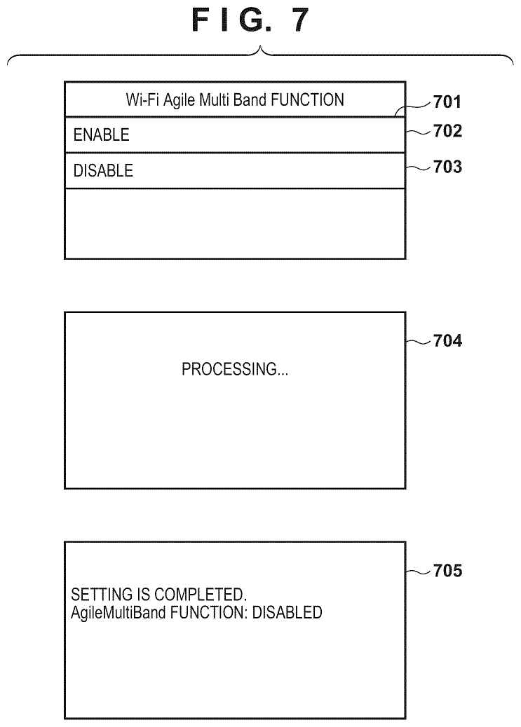

FIG. 7 is a view showing an example of a screen configured to switch enable/disable of the function released to the public as Wi-Fi Agile Multiband® described with reference to FIG. 6. In this embodiment, the function released to the public as Wi-Fi Agile Multiband® is a function of changing the connection destination AP in accordance with a connection destination AP change request (BTM request). The function of changing the connection destination AP in accordance with the connection destination AP change request (BTM request) will be referred to as a connection destination AP change function hereinafter. In other words, the connection destination AP change function is the Wi-Fi Agile Multiband function. A screen shown in FIG. 7 is displayed by, for example, selection from a menu item group corresponding to “wireless LAN” on the menu screen of the communication setting in FIG. 3C on the display included in the operation display unit 220 of the MFP 100.

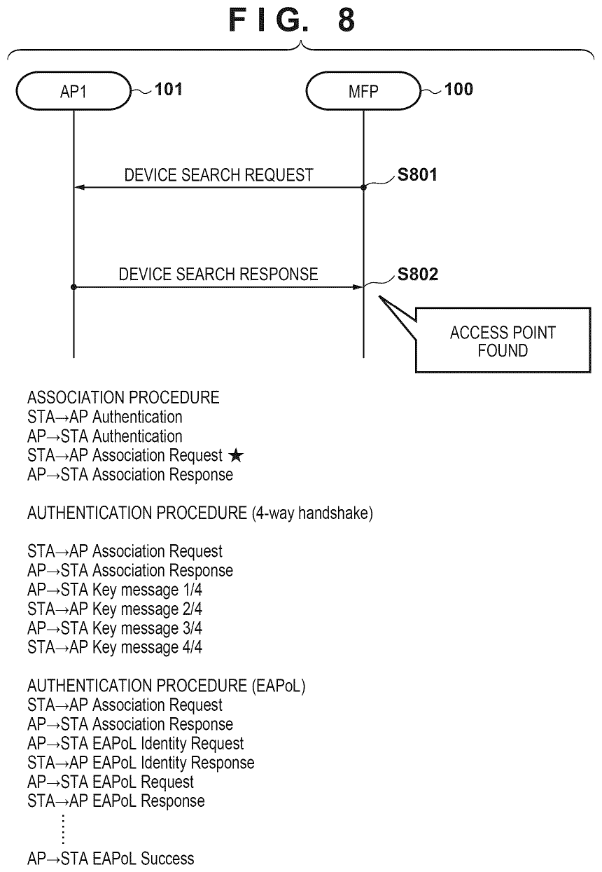

On a Wi-Fi Agile Multiband function setting screen 701 (to be simply referred to as a function setting screen 701 hereinafter), items for switching whether to enable the connection destination AP change function or disable are selectably displayed. If an “enable” item 702 is selected, the connection destination AP change function is set to be enabled, and a device search request at the time of connection to an AP shown in FIG. 8 is executed in accordance with the set contents. If a “disable” item 703 is selected, the connection destination AP change function is set to be disabled, and a device search request at the time of connection to an AP shown in FIG. 8 is executed in accordance with the set contents. Note that in a state in which the connection destination AP change function is set to be enabled, upon receiving a connection destination AP change request, the MFP 100 transmits a response indicating approval of switching and complies with the connection destination AP change request. On the other hand, in a state in which the connection destination AP change function is set to be disabled, even upon receiving a connection destination AP change request, the MFP 100 does not transmit a response indicating approval of switching and does not comply with the connection destination AP change request.

If one of the items is selected on the function setting screen 701, a set value corresponding to the selected item is saved in the RAM 214 and the nonvolatile memory 215 of the MFP 100. During the saving, a processing progress screen 704 is displayed. When the saving is completed, a notification screen 705 indicating that the change of the setting of the Wi-Fi Agile Multiband function is completed is displayed. The notification screen 705 is an example of a screen displayed in a case where the item 703 is selected on the function setting screen 701.

Next, device search response processing at the time of connection of an AP will be described with reference to the sequence shown in FIG. 8. The sequence shown in FIG. 8 is implemented by, for example, reading out a program stored in a ROM to a RAM and executing it by the CPU of each apparatus. The MFP 100 recognizes the presence of the AP 101, transmits a Probe Request (device search request) to the AP 101 in S801, and receives a Probe Response (device search response) from the AP 101 in S802, thereby determining that it is possible to start link establishment. The AP 101 and the MFP 100 establish a link by performing authentication communication. The authentication communication includes steps of Authentication, Association Request, Association Response, and 4-way handshake.

If the connection destination AP change function is set to be disabled by selecting the item 703 on the function setting screen 701 in FIG. 7, the flag of BSS Transition SUPPORT of Association Request is disabled and transmitted. The AP 101 then determines that the MFP 100 does not support the connection destination AP change function. In S605 of FIG. 6, the AP 101 controls not to transmit the connection destination AP change request to the MFP 100.

### <Connection Setting Processing>

In this embodiment, using wireless communication with the MFP 100, the mobile terminal device 104 executes connection setting (network setting) that is a setting for causing the MFP 100 to operate by at least one communication method of infrastructure connection and direct connection. Connection setting processing according to this embodiment is executed by wireless communication and is therefore called cableless setup (CLS). Note that the connection setting processing may be executed by wired communication. When a predetermined application stored in the ROM 413 or the like is activated, the mobile terminal device 104 performs connection setting processing for the MFP 100. The MFP 100 can operate in a connection setting mode (connection setting state) that is a mode for executing connection setting processing, and executes connection setting processing in a state in which the MFP 100 operates in the connection setting mode to be described later. Details of the connection setting mode will be described later.

To cause the MFP 100 to operate in the infrastructure connection mode, the mobile terminal device 104 wirelessly transmits, to the MFP 100, infrastructure setting information that is setting information used to cause the MFP 100 to operate in the infrastructure connection mode. The infrastructure setting information includes information about the AP 101. Information about the AP 101 is, for example, information about a Service Set Identifier (SSID), a password, and a frequency band.

On the other hand, to cause the MFP 100 to operate in the direct connection mode, the mobile terminal device 104 wirelessly transmits, to the MFP 100, direct setting information that is setting information used to cause the MFP 100 to operate in the direct connection mode. The direct setting information includes an instruction for enabling the WFD function and causing the MFP 100 to operate as a Group Owner or an instruction for enabling the access point setting of the MFP 100. Also, the mobile terminal device 104 obtains, from the MFP 100, connection information necessary for direct-connecting to the MFP 100. The connection information for direct-connecting to the MFP 100 includes, for example, information of the SSID and password of the MFP 100 that operates in the direct connection mode.

In this embodiment, direct connection for connection setting between the mobile terminal device 104 and the MFP 100 is used to transmit the infrastructure setting information or direct setting information and obtain the information used to direct-connect to the MFP 100 in the connection setting processing. In this embodiment, connection setting processing using Wi-Fi is executed as direct connection for connection setting. For example, a wireless communication standard other than Wi-Fi, such as Bluetooth may be used. In addition, a wired communication standard such as a wired LAN or Universal Serial Bus (USB) may be used as the direct connection for connection setting.

After infrastructure connection or direct connection by Wi-Fi is established between the mobile terminal device 104 and the MFP 100 by the connection setting processing, communication can be performed between the mobile terminal device 104 and the MFP 100 via the established connection. More specifically, for example, the mobile terminal device 104 can transmit a print job for causing the MFP 100 to perform printing or a scan job for causing the MFP 100 to execute scan to the MFP 100 via the established connection. Note that in this embodiment, it is possible to cause the MFP 100 to operate both in the infrastructure connection mode and in the direct connection mode by connection setting processing, but the present disclosure is not limited to this form. For example, it may be possible to only cause the MFP 100 to operate in the infrastructure connection mode by connection setting processing (that is, the MFP 100 cannot be operated in the direct connection mode).

### <Connection Setting Mode>

The MFP 100 can operate in the connection setting mode. As a trigger for the MFP 100 to start the operation in the connection setting mode, for example, the user may press a connection setting mode button or the MFP 100 may be activated (powered on) for the first time after arrival. The connection setting mode button may be a physical button provided on the MFP 100 or a software button that the MFP 100 displays on an operation display unit 205.

When the operation in the connection setting mode is started, the MFP 100 enables both Wi-Fi communication and BLE communication. More specifically, as processing of enabling Wi-Fi communication, the MFP 100 enables an AP (connection setting AP) in the MFP 100, which is dedicated to the connection setting mode. The MFP 100 is thus set in a state in which it can establish direct connection by Wi-Fi with the mobile terminal device 104. Connection information (an SSID and a password) used to connect to the connection setting AP is held in advance in a predetermined application installed in the mobile terminal device 104. That is, the mobile terminal device 104 recognizes the connection information used to connect to the connection setting AP in advance. For this reason, unlike the connection information of the AP enabled in the direct connection mode, the connection information used to connect to the connection setting AP cannot arbitrarily be changed by the user. Note that all character strings of the SSID of the connection setting AP may be held in the predetermined application in advance, or some character strings of the SSID of the connection setting AP may be held in the predetermined application in advance. Also, of the SSID of the connection setting AP, only some character strings recognized by the predetermined application may be arbitrarily unchangeable, and character strings other than the some character strings may be arbitrarily changeable. In addition, an encryption method may not be set for the connection setting AP, and no password is necessary for connection to the AP.

Note that in the connection setting mode, the MFP 100 may be connected to the mobile terminal device 104 not by normal Wi-Fi but by Wi-Fi Direct (WFD). That is, the MFP 100 may operate as a Group Owner and receive a setting command from the mobile terminal device 104 by communication by WFD. Also, the MFP 100 operating in the connection setting mode uses a predetermined communication protocol (setup communication protocol) in the communication with the mobile terminal device 104 connected to the connection setting AP. More specifically, the setup communication protocol is, for example, the Simple Network Management Protocol (SNMP). If a predetermined time elapses after the start of the operation in the connection setting mode, the MFP 100 stops the operation in the connection setting mode and disables the connection setting AP. Also, the MFP 100 disables the connection setting AP even in a case where connection information used to connect to an external AP and an instruction to change the operation mode of wireless communication are received from the mobile terminal device 104 during the connection setting mode.

The mobile terminal device 104 executes connection setting processing when the CPU 412 reads out a predetermined computer program stored in the ROM 413 and executes it. The predetermined program is an application program including not only a function of executing connection setting processing and but also a printing function of causing the MFP 100 to print image data or document data in the mobile terminal device 104, which is the above-described setup application. Note that the setup application may include functions other than the function of executing connection setting processing and the printing function. For example, the setup application may include a function of causing the MFP 100 to scan a set original, a function of executing another setting of the MFP 100, and a function of confirming the state of the MFP 100. The setup application of the mobile terminal device 104 establishes connection as a client to the SSID for which the MFP 100 is activated in the connection setting mode.

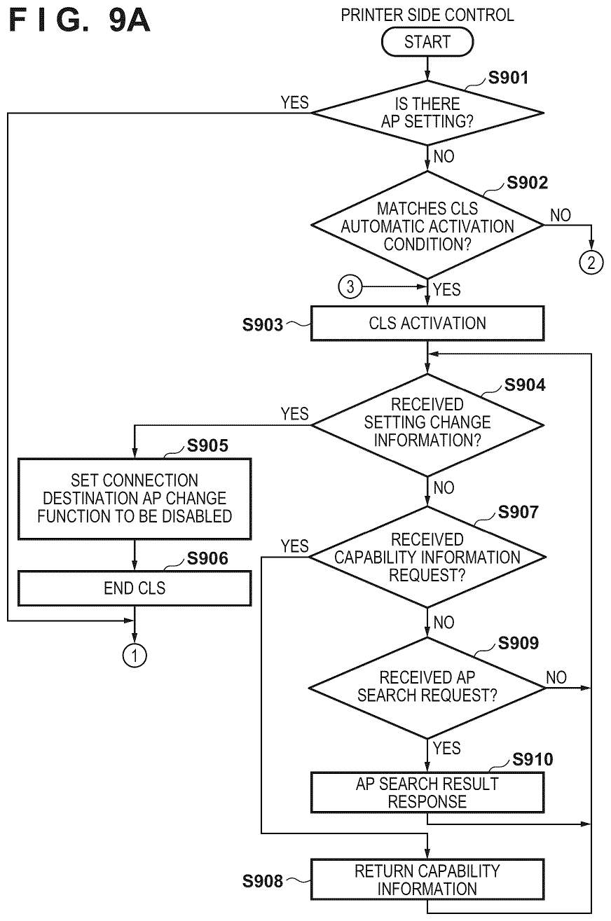

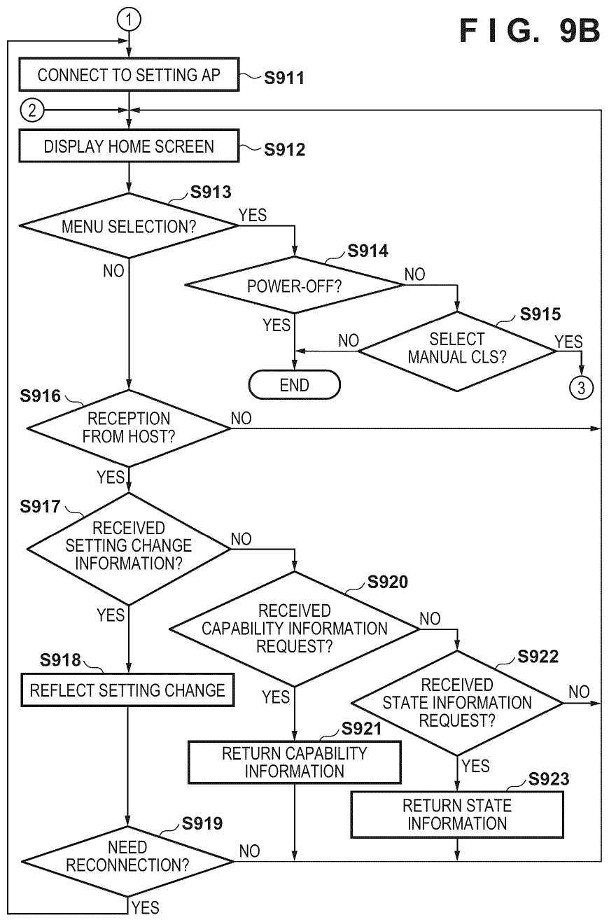

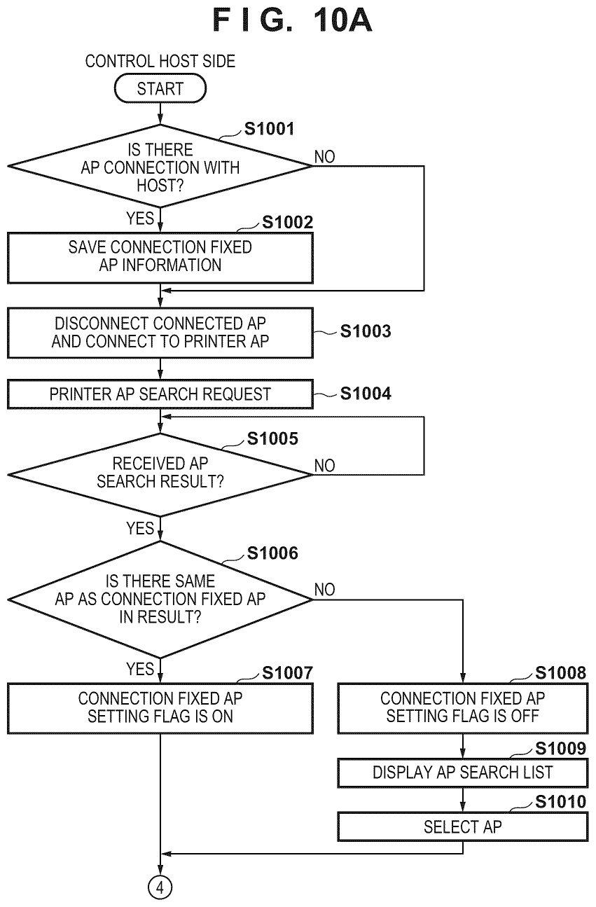

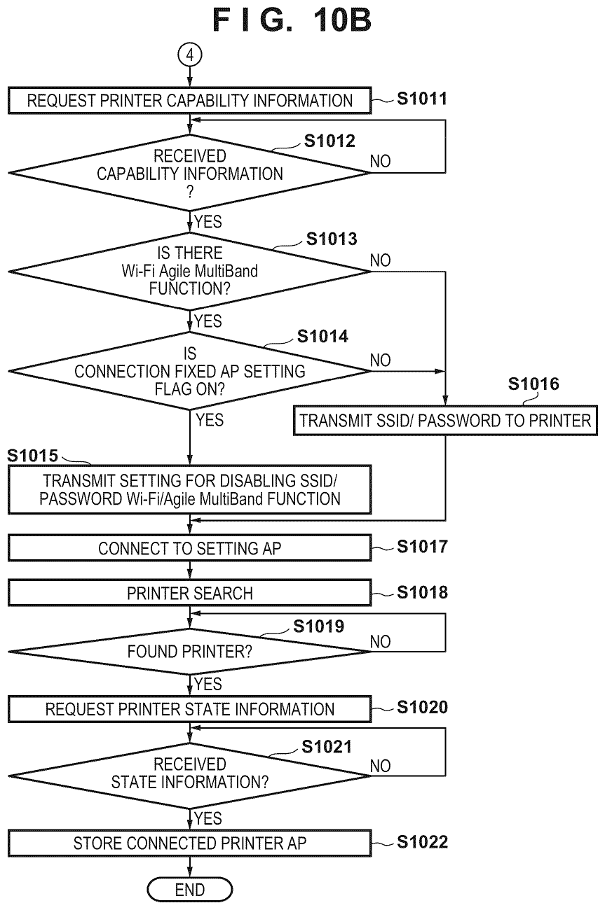

Processing of executing connection setting processing from power-ON of the MFP 100 will be described next with reference to the flowcharts of FIGS. 9 and 10. Processing shown in FIGS. 9A and 9B is implemented by, for example, reading out a computer program stored in the ROM 213 and executing it by the CPU 212 of the MFP 100. Processing shown in FIGS. 9A and 9B is started based on power-ON of the MFP 100.

In step S901, the CPU 212 determines whether a setting of an external access point (external AP) is held in the MFP 100. More specifically, for example, the CPU 212 refers to a wireless profile stored in the MFP 100 and determines whether connection information (SSID and the like) to an external AP to which the MFP 100 was connected is held. Upon determining that a setting of an external AP is not held, in step S902, it is determined whether a condition to automatically start connection setting processing for connecting to an external AP is satisfied. In other words, the determination of step S902 is determining whether a condition for activating the MFP 100 in the connection setting mode is satisfied. In step S902, more specifically, for example, if network setting of a LAN or the like is not performed yet, it is determined that the condition to automatically start connection setting processing for connecting to an external AP is satisfied. Also, for example, if WiFi-Direct is not set to always activation, it is determined that the condition to automatically start connection setting processing for connecting to an external AP is satisfied. Upon determining in step S902 that the condition is satisfied, in step S903, the CPU 212 activates the MFP 100 in the connection setting mode. On the other hand, upon determining that the condition is not satisfied, the process advances to step S912.

In step S903, the CPU 212 activates the MFP 100 in the connection setting mode. More specifically, for example, the CPU 212 controls to output a beacon signal including a predetermined SSID. In step S904, the CPU 212 determines whether a setting change request that is a command for changing the setting of the apparatus is received from the mobile terminal device 104. In other words, the command for changing the setting of the apparatus is a setting instruction for, if a setting associated with the connection destination AP change function is set to be enabled, switching the setting to the disabled state. Note that reception of the setting change request here is processing corresponding to step S1015 in FIGS. 10A and 10B. Hence, in step S904, if the setting change request is received from the mobile terminal device 104, connection information to an external AP is also received.

Upon determining in step S904 that the setting change request is received, in step S905, if the connection destination AP change function is enabled, the CPU 212 switches the setting to the disabled state. If the connection destination AP change function is set to be disabled, the CPU 212 maintains the setting of disabled. In step S906, the CPU 212 stops the connection setting mode. In step S911, the CPU 212 executes connection to an external AP by processing shown in FIG. 8 based on the connection information to the external AP received from the mobile terminal device 104.

On the other hand, upon determining in step S904 that the setting change request is not received, the process advances to step S907. In step S907, the CPU 212 determines whether a capability information request is received from the mobile terminal device 104. The capability information request is a request for information indicating whether the MFP 100 supports the Wi-Fi Agile Multiband function. Note that the capability information request is different from the setting information on the function setting screen 701 shown in FIG. 7. Upon determining in step S907 that the capability information request is received, in step S908, the CPU 212 returns capability information, that is, information indicating whether the MFP 100 supports the Agile Multiband function to the mobile terminal device 104, and repeats the processing from step S904. Note that reception of the capability information request here is processing corresponding to step S1011 in FIGS. 10A and 10B.

Upon determining in step S907 that the capability information request is not received, in step S909, the CPU 212 determines whether an AP search request is received from the mobile terminal device 104. The AP search request is a command transmitted from the mobile terminal device 104 in step S1004 of FIGS. 10A and 10B. That is, reception of the AP search request is processing corresponding to step S1004 in FIGS. 10A and 10B. Upon determining that the AP search request is received, in step S910, the CPU 212 executes an AP search and transmits, to the mobile terminal device 104 as an AP search result, a list indicating one or a plurality of access points which are discovered as a result and to which the MFP 100 can be connected. After that, the CPU 212 repeats the processing from step S904.

In step S911, the CPU 212 establishes connection to an external AP by processing shown in FIG. 8. The external AP for which connection is established at this time is, for example, an external AP whose setting is held in the MFP 100 in a case where it is determined in step S901 that the setting of an external access point (external AP) is held in the MFP 100. Alternatively, for example, it is an external AP corresponding to the connection information to an external AP received from the mobile terminal device 104 in step S904.

In step S912, the CPU 212 displays a home screen on the operation display unit 220. The home screen is a screen capable of accepting user selection of each menu such as print or scan.

In step S913, the CPU 212 determines whether menu selection is accepted on the home screen. Upon determining that menu selection is accepted, the process advances to step S914.

In step S914, the CPU 212 determines whether selection of power-OFF is accepted. Upon determining that selection of power-OFF is accepted, the processing shown in FIGS. 9A and 9B is ended. On the other hand, upon determining that selection of power-OFF is not accepted, the process advances to step S915.

In step S915, the CPU 212 determines whether a menu to manually activate the connection setting mode is selected. Upon determining that a menu to manually activate the connection setting mode is selected, the CPU 212 repeats the processing from step S903. On the other hand, upon determining that a menu to manually activate the connection setting mode is not selected, the processing shown in FIGS. 9A and 9B is ended, and the CPU 212 executes processing according to the selected menu.

Upon determining in step S913 that menu selection is not accepted, the process advances to step S916.

In step S916, the CPU 212 determines whether reception from the mobile terminal device 104 via the connected external AP exists. More specifically, for example, if one of print target data, a setting change request, a capability information request, a state information request (to be described later) is received, it is determined that reception from the mobile terminal device 104 exists, and the process advances to step S917. Upon determining that reception from the mobile terminal device 104 via the connected external AP does not exist, the CPU 212 repeats the processing from step S912.

In step S917, the CPU 212 determines whether the reception from the mobile terminal device 104 is reception of a setting change request. Upon determining that the reception is reception of a setting change request, the process advances to step S918. Note that the setting change request here is a setting change request received from the mobile terminal device 104 via the external AP. Upon determining that the reception is not reception of a setting change request, the process advances to step S920.

In step S918, the CPU 212 changes the setting associated with the connection destination AP change function based on the received setting change request. More specifically, for example, if the connection destination AP change function is set to be disabled, it is switched to the enabled state. After that, the process advances to step S919.

In step S919, the CPU 212 determines whether the MFP 100 needs to be reactivated in accordance with the change of the setting. Upon determining that the MFP 100 needs to be reactivated, the MFP 100 is reactivated. In step S911, connection to the external AP is established again, and the process advances to step S912. On the other hand, upon determining that the MFP 100 need not be reactivated, the CPU 212 repeats the processing from step S912.

In step S920, the CPU 212 determines whether the reception from the mobile terminal device 104 is reception of a capability information request. Upon determining that the reception is reception of a capability information request, the process advances to step S921. Note that the capability information request here is a capability information request received from the mobile terminal device 104 via the external AP. Upon determining that the reception is not reception of a capability information request, the process advances to step S922.

In step S921, based on the received capability information request, the CPU 212 transmits information indicating whether the MFP 100 supports the Wi-Fi Agile Multiband function to the mobile terminal device 104. After that, the CPU 212 repeats the processing from step S912.

In step S922, the CPU 212 determines whether the reception from the mobile terminal device 104 is reception of a state information request. Upon determining that the reception is reception of a state information request, the process advances to step S923. In step S923, the CPU 212 transmits state information to the mobile terminal device 104. In this embodiment, the state information is the connection information of the external AP to which the MFP 100 is connected (is being connected), and is, for example, an SSID or BSSID. Also, here, the state information request is a state information request received from the mobile terminal device 104 via the external AP, and the processing corresponds to step S1020 in FIGS. 10A and 10B. Upon determining that the reception is not reception of a state information request, the CPU 212 repeats the processing from step S912. In step S923, it is possible to notify the setup application of the mobile terminal device 104 of the information of the AP that is stationarily set as the connection destination AP because the connection destination AP change function is set to be disabled on the function setting screen 701 shown in FIG. 7.

As described above, in steps S917 and S920, the setting change request and the capability information request are received from the mobile terminal device 104 via the external AP. For example, in the following cases, the above-described requests can be received from the mobile terminal device 104 via the external AP.

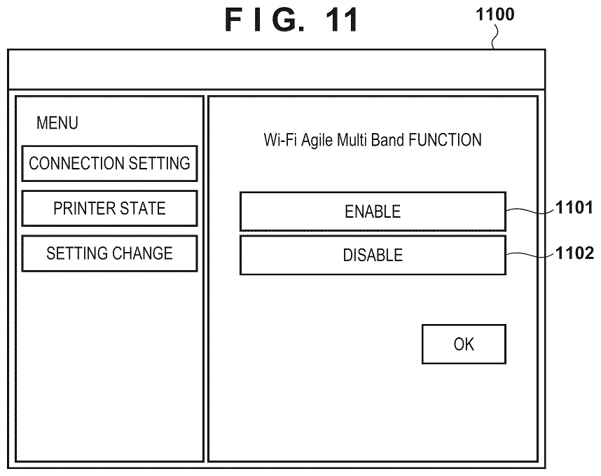

As will be described later, in FIGS. 10A and 10B, the mobile terminal device 104 is connected, by wireless direct, to the MFP 100 that has activated the connection setting mode, and transmits the connection information of the external AP to the MFP 100. After that, the mobile terminal device 104 searches for the MFP 100 on the network formed by the external AP and is set in a state in which it can communicate with the MFP 100. At this time, to register the information of the MFP 100 on the setup application, the mobile terminal device 104 requests capability information from the MFP 100. The request of capability information may include a capability information request. Then, based on the capability information received from the MFP 100, the mobile terminal device 104 controls, on the setup application, whether to display a screen for changing the setting of the MFP 100. More specifically, for example, if the received capability information indicates that the MFP 100 supports the Agile Multiband function, the mobile terminal device 104 controls to display the screen for changing the setting of the MFP 100. The screen here is a function setting screen configured to allow the mobile terminal device 104 to designate the enable/disable of the connection destination AP change function in the MFP 100. FIG. 11 is a view showing an example of the function setting screen on the setup application. As shown in FIG. 11, an item 1101 indicating “enable” and an item 1102 indicating “disable” are displayed on a function setting screen 1100 in accordance with selection of a menu item of “setting change”. When the item 1101 is selected, the connection destination AP change function in the MFP 100 can be set to be enabled from the mobile terminal device 104. When the item 1102 indicating “disable” is selected, the connection destination AP change function in the MFP 100 can be set to be disabled from the mobile terminal device 104. The setting information accepted from the user on the function setting screen 1100 is transmitted to the MFP 100 via the external AP. Hence, the setting change request received from the mobile terminal device 104 via the external AP is, for example, the setting information accepted on the function setting screen 1100.

For example, after connection confirmation (connectivity test) between the mobile terminal device 104 and the MFP 100 via the external AP is performed, if the mobile terminal device 104 and the MFP 100 need not be connected to the same network, a set value for enabling the connection destination AP change function set on the function setting screen 1100 may be transmitted to the MFP 100.

On the other hand, if the received capability information indicates that the MFP 100 does not support the Agile Multiband function, the mobile terminal device 104 controls not to display the screen for changing the setting of the MFP 100. For example, in this case, display control is performed such that the menu item of “setting change” cannot be selected on the function setting screen 1100.

Processing of the mobile terminal device 104 will be described next with reference to FIGS. 10A and 10B. Processing shown in FIGS. 10A and 10B is implemented by, for example, reading out a setup application stored in the ROM 413 and executing it by the CPU 412 of the mobile terminal device 104.

In step S1001, the CPU 412 determines whether the mobile terminal device 104 is connected to an external AP. Upon determining that the mobile terminal device 104 is connected to an external AP, in step S1002, the CPU 412 saves the connection information (for example, an SSID, a password, and an encryption method) of the external AP and advances to step S1003. Upon determining that the mobile terminal device 104 is not connected to an external AP, the process advances to step S1003 without executing the processing of step S1002.

In step S1003, the CPU 412 searches for an MFP that activates the connection setting mode. Here, assume that the MFP 100 that activates the connection setting mode is discovered as the result of the search. The CPU 412 establishes connection by wireless direct as a client to a predetermined SSID of the MFP 100 that activates the connection setting mode. The CPU 412 then disconnects communication with the external AP determined to be connected in step S1001.

In step S1004, the CPU 412 requests an AP search from the MFP 100. In step S1005, the CPU 412 determines whether an AP search result is received from the MFP 100. The processing of step S1005 is repeated until it is determined that an AP search result is received. Upon determining that an AP search result is received, the process advances to step S1006.

In step S1006, the CPU 412 determines whether the received AP search result includes an external AP corresponding to the connection information saved in step S1002. The external AP corresponding to the connection information saved in step S1002 will be referred to as a connection fixed AP hereinafter. Upon determining that the AP search result includes the connection fixed AP, the process advances to step S1007. Upon determining that the AP search result does not include the connection fixed AP, the process advances to step S1008.

In step S1007, the CPU 412 turns on a connection fixed AP setting flag stored in the RAM 414 or the like in advance. After that, the process advances to step S1011. On the other hand, in step S1008, the CPU 412 turns off the connection fixed AP setting flag stored in the RAM 414 or the like in advance. If the process advances to step S1008, it means that the MFP 100 is to be connected to an external AP different from the external AP connected to the mobile terminal device 104. After step S1008, in step S1009, the CPU 412 displays an AP search result list on the display unit 420 to cause the user to select an external AP to be connected to the MFP 100. In step S1010, the CPU 412 accepts selection of an external AP by the user. After that, the process advances to step S1011.

In step S1011, the CPU 412 transmits a capability information request to the MFP 100. In step S1012, the CPU 412 determines whether capability information is received. The processing of step S1012 is repeated until it is determined that capability information is received. Upon determining that capability information is received, the process advances to step S1013.

In step S1013, the CPU 412 determines, based on the received capability information, whether the MFP 100 supports the Wi-Fi Agile Multiband function. Upon determining that the MFP 100 supports the Wi-Fi Agile Multiband function, the process advances to step S1014.

In step S1014, the CPU 412 determines whether the connection fixed AP setting flag is on. Upon determining that the connection fixed AP setting flag is on, the process advances to step S1015. That the connection fixed AP setting flag is on means that the connection fixed AP is included in the AP search result received from the MFP 100. This also means that the user wants the MFP 100 to be connected to the connection fixed AP. In step S1015, the CPU 412 transmits a set value for disabling the connection destination AP change function to the MFP 100 together with the connection information saved in step S1002. Here, the set value for disabling the connection destination AP change function is transmitted regardless of what value is currently set on the function setting screen of the MFP 100 in FIG. 7. After that, the process advances to step S1017.

On the other hand, upon determining in step S1013 that the MFP 100 does not support the Wi-Fi Agile Multiband function or upon determining in step S1014 that the connection fixed AP setting flag is not on, the process advances to step S1016.

If the process advances from step S1014 to step S1016, the CPU 412 transmits the connection information of the external AP whose selection is accepted in step S1010 to the MFP 100. After that, the process advances to step S1017. If the process advances from step S1013 to step S1016, the CPU 412 transmits the connection information of the external AP saved in step S1002 or the connection information of the external AP whose selection is accepted in step S1010 to the MFP 100. After that, the process advances to step S1017.

Note that if it is determined in step S1013 that the MFP 100 supports the Wi-Fi Agile Multiband function, the process may advance to step S1015 without performing the processing of step S1014. In each of steps S1015 and S1016, upon determining in step S1006 that the AP search result includes the connection fixed AP, the connection information saved in step S1002 is transmitted. On the other hand, upon determining in step S1006 that the AP search result does not include the connection fixed AP, the connection information of the external AP selected in step S1010 is transmitted.

In step S1017, if there exists connection information saved in step S1002, the CPU 412 establishes connection to the connection fixed AP. On the other hand, if there does not exist connection information saved in step S1002, the CPU 412 establishes connection to the external AP selected in step S1010. Note that connection to the external AP corresponding to the connection information transmitted in step S1015 or S1016 may be established regardless of the presence/absence of connection information saved in step S1002.

In step S1018, the CPU 412 searches for the MFP 100 that has transmitted the connection information on the network formed by the external AP whose connection is established in step S1017. In step S1019, the CPU 412 determines whether the MFP 100 is discovered on the network formed by the external AP whose connection is established in step S1017. Upon determining that the MFP 100 is discovered, the process advances to step S1020. The CPU 412 repeats the processing of step S1019 until it is determined that the MFP 100 is discovered. Alternatively, the processing shown in FIGS. 10A and 10B may be ended by timeout.

In step S1020, the CPU 412 transmits a command for requesting state information to the MFP 100. The state information is the connection information of the external AP connected to the MFP 100, and is, for example, an SSID or a BSSID. In step S1021, the CPU 412 determines whether state information is received from the MFP 100. Upon determining that state information is received, in step S1022, the CPU 412 stores the connection information of the external AP connected to the MFP 100, which is included in the state information. After that, the processing shown in FIGS. 10A and 10B is ended.

As described above, according to this embodiment, when executing connection setting processing from the mobile terminal device 104, control can be performed such that the connection destination AP change function is not executed in the MFP 100. It is therefore possible to, for example, prevent, when performing connection setting processing for connecting the MFP 100 to a specific external AP, a separator function from being enabled as the result of changing the connection destination AP of the MFP 100 or connectivity test between the MFP 100 and the mobile terminal device 104 from being impossible due to disconnection/reconnection that occurs upon changing the connection destination AP.

Note that as described above, in this embodiment, when executing connection setting processing from the mobile terminal device 104, the connection destination AP change function is changed to the disabled state. In other words, in this embodiment, in a state in which the MFP 100 is connected to an AP by connection setting processing executed by the mobile terminal device 104, control is performed such that the connection destination AP change function is not executed. A case where the connection destination AP change function is executed will be described below. As described above, if a wireless LAN is set to be enabled by a user operation, the infrastructure connection mode is enabled. At this time, more specifically, the MFP 100 searches for APs on the periphery and displays a list of discovered APs. If the user selects one AP from the list, the MFP 100 accepts, from the user, input of a password for connecting to the selected AP. If input of a password is accepted, the MFP 100 attempts to establish connection to the selected AP using the password. If a correct password is input, connection succeeds, and connection between the MFP 100 and the AP is established. That is, in this embodiment, the MFP 100 can be connected to the AP not only when connection setting processing is executed from the mobile terminal device 104 but also when a predetermined operation for connection to the AP is executed for the MFP 100. In other words, connection to the AP established by executing a predetermined operation is connection to the AP established without receiving infrastructure setting information from the mobile terminal device 104 that executes connection setting processing. Note that the MFP 100 may be able to establish connection to the AP by Wi-Fi Protected Setup (WPS) by accepting an operation for WPS. That is, connection to the AP established by executing a predetermined operation may be connection to the AP established by WPS.

In this embodiment, if connection between the MFP 100 and the AP is established without receiving infrastructure setting information from the mobile terminal device 104, the MFP 100 does not change the setting of the connection destination AP change function, unlike a case where connection between the MFP 100 and the AP is established by receiving infrastructure setting information from the mobile terminal device 104. That is, in a state in which the connection is maintained, whether to execute the connection destination AP change function is switched based on whether the connection destination AP change function is set to be enabled or disabled. More specifically, in the state, if the connection destination AP change function is set to be enabled, the MFP 100 executes the connection destination AP change function as described with reference to FIG. 6. In the state, if the connection destination AP change function is set to be disabled, the MFP 100 controls not to execute the connection destination AP change function.

Also, after the connection destination AP change function is set to be disabled by executing connection setting processing from the mobile terminal device 104, in a state in which connection between the MFP 100 and the AP established by the connection setting processing is maintained, the MFP 100 may perform control to disable an operation to the function setting screen 701 shown in FIG. 7 such that the connection destination AP change function cannot be set to be enabled. If connection between the MFP 100 and the AP established by the connection setting processing is disconnected, the MFP 100 may perform control to enable the operation to the function setting screen 701 shown in FIG. 7 such that the connection destination AP change function can be set to be enabled. However, the present disclosure is not limited to this form. After the connection destination AP change function is set to be disabled by executing connection setting processing from the mobile terminal device 104, in a state in which connection between the MFP 100 and the AP established by the connection setting processing is maintained, the MFP 100 may perform control to enable the operation to the function setting screen 701 shown in FIG. 7 such that the connection destination AP change function can be set to be enabled. In a state in which connection between the MFP 100 and the AP established by the connection setting processing is maintained, if the connection destination AP change function is set to be enabled by the operation to the function setting screen 701 shown in FIG. 7, the MFP 100 may execute the connection destination AP change function even in the state in which connection between the MFP 100 and the AP established by the connection setting processing is maintained. Although the present disclosure has been described in detail based on its preferred embodiments, the present disclosure is not limited to these specific embodiments, and also includes various forms without departing from the spirit and scope of the disclosure. Further, the above-described embodiments are merely embodiments of the present disclosure. In the above-described embodiments, an example in which the present disclosure is applied to an electronic device has been described. However, the present disclosure is not limited to this example, and is applicable to a wireless device that functions as an STA capable of processing corresponding to a connection destination change request from an AP.

That is, the present disclosure is applicable to a personal computer, a PDA, a tablet terminal, a mobile phone terminal such as a smartphone, a music player, a game device, an electronic book reader, a smartwatch, and various measurement devices (sensor devices) such as a thermometer and a hygrometer. The present disclosure is applicable to digital cameras (including a still camera, a video camera, a network camera, and a security camera), a printer, a scanner, and a drone. The present disclosure is applicable to a video output device, an audio output device (for example, a smart speaker), a media streaming player, and a wireless LAN slave device (adaptor) capable of connecting to a USB terminal or a LAN cable terminal. The video output device includes, for example, a device that implements streaming playback on a display device by obtaining (downloading) a movie on the Internet specified by a URL designated from an electronic device and outputting it to the display device connected via a video output terminal such as HDMI™, and a device that implements mirroring display (display in which contents displayed on an electronic device are also displayed on a display device). The video output device also includes media players such as a television, a hard disk recorder, a Blu-ray recorder, and a DVD recorder, a head-mounted display, a projector, a television, a display device (monitor), and a signage device. The present disclosure is applicable to even Wi-Fi connectable devices called smart home appliances such as an air conditioner, a refrigerator, a washing machine, a cleaner, an oven, a microwave oven, lighting equipment, a heating appliance, and cooling equipment.

According to the present disclosure, it is possible to control execution possibility of a function of changing a connection destination AP.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-107639, filed Jul. 3, 2024, which is hereby incorporated by reference herein in its entirety.

What is claimed is:

1. A communication apparatus comprising
at least one memory and at least one processor which function as:
a reception unit configured to receive information used to connect to a first access point from a terminal device;
a first establishment unit configured to establish connection between the communication apparatus and the first access point based on reception of the information used to connect to the first access point from the terminal device;
a first execution unit configured to execute, based on the reception of the information used to connect to the first access point, a first setting for inhibiting the communication apparatus from executing change processing of changing a connection destination of the communication apparatus from the first access point to a second access point in response to a change request transmitted from the first access point; and
a second execution unit configured to execute, based on performing of communication with the terminal device via the first access point, a second setting for allowing the communication apparatus to execute the change processing after the connection between the communication apparatus and the first access point is established.

2. The apparatus according to claim 1, wherein
in a case where the first setting is performed, the communication apparatus does not comply with the change request even if the change request is received.

3. The apparatus according to claim 1, wherein
in a case where the first setting is performed, the communication apparatus does not transmit a response indicating approval of change of the connection destination of the communication apparatus to the first access point even if the change request is received.

4. The apparatus according to claim 1, wherein
the at least one processor further function as:
a display unit configured to display a screen configured to accept an operation for the first setting or an operation for the second setting,
the first setting is executed based on acceptance of the operation for the first setting on the screen, and
the second setting is executed based on acceptance of the operation for the second setting on the screen.

5. The apparatus according to claim 4, wherein
the at least one processor further function as:
a first control unit configured to control not to execute the second setting based on the operation on the screen in a state in which the connection between the communication apparatus and the first access point established based on the reception of the information used to connect to the first access point is maintained.

6. The apparatus according to claim 5, wherein
the at least one processor further function as:
a second control unit configured to perform control to execute the second setting based on the operation on the screen in a case where the connection between the communication apparatus and the first access point established based on the reception of the information used to connect to the first access point is disconnected.

7. The apparatus according to claim 4, wherein
in a state in which the connection between the communication apparatus and the first access point established based on the reception of the information used to connect to the first access point is maintained, in a case where the operation for the second setting is accepted on the screen, the second setting is executed even if the connection between the communication apparatus and the first access point is maintained.

8. The apparatus according to claim 1, wherein
the at least one processor further function as:
a second establishment unit configured to establish the connection between the communication apparatus and the first access point without receiving the information used to connect to the first access point from the terminal device.

9. The apparatus according to claim 8, wherein
in a case where the connection between the communication apparatus and the first access point is established without receiving the information used to connect to the first access point from the terminal device, the first setting is not executed.

10. The apparatus according to claim 8, wherein
processing of establishing the connection between the communication apparatus and the first access point without receiving the information used to connect to the first access point from the terminal device includes processing of displaying a list of access points discovered by the communication apparatus upon a search, and processing of accepting, from a user, input of a password used to connect to the first access point selected from the list by the user.

11. The apparatus according to claim 8, wherein
processing of establishing the connection between the communication apparatus and the first access point without receiving the information used to connect to the first access point from the terminal device is processing of establishing the connection between the communication apparatus and the first access point by Wi-Fi Protected Setup (WPS).

12. The apparatus according to claim 1, wherein
the first setting is executed at a timing after the information used to connect to the first access point is received and before the connection between the communication apparatus and the first access point is established.

13. The apparatus according to claim 1, wherein
the information used to connect to the first access point is received via direct connection between the communication apparatus operating in a predetermined mode and the terminal device.

14. The apparatus according to claim 1, wherein
the second setting is executed based on reception of information used to instruct change of the first setting from the terminal device as the communication with the terminal device via the first access point.

15. The apparatus according to claim 1, wherein
the at least one processor further function as:
a transmission unit configured to transmit, to the terminal device, information indicating that a function for executing the change processing is supported.

16. The apparatus according to claim 1, wherein
the at least one processor further function as:
a transmission unit configured to transmit, to the terminal device, a list of one or a plurality of access points discovered by the communication apparatus upon a search, and
the first access point is an access point included in the list.

17. The apparatus according to claim 1, wherein
the at least one processor further function as:
a printing unit configured to execute printing.

18. The apparatus according to claim 1, wherein
the change processing is processing executed based on Wi-Fi Agile Multiband.

19. A control method of a communication apparatus, comprising:
receiving information used to connect to a first access point from a terminal device;
establishing connection between the communication apparatus and the first access point based on reception of the information used to connect to the first access point from the terminal device;
executing, based on the reception of the information used to connect to the first access point, a first setting for inhibiting the communication apparatus from executing change processing of changing a connection destination of the communication apparatus from the first access point to a second access point in response to a change request transmitted from the first access point; and
executing, based on performing of communication with the terminal device via the first access point, a second setting for allowing the communication apparatus to execute the change processing after the connection between the communication apparatus and the first access point is established.

20. A non-transitory computer-readable storage medium that stores one or more programs including instructions, which when executed by one or more processors of an electronic device, cause the electronic device to:
receive information used to connect to a first access point from a terminal device;
establish connection between the electronic apparatus and the first access point based on reception of the information used to connect to the first access point from the terminal device;
execute, based on the reception of the information used to connect to the first access point, a first setting for inhibiting the communication apparatus from executing change processing of changing a connection destination of the communication apparatus from the first access point to a second access point in response to a change request transmitted from the first access point; and
execute, based on performing of communication with the terminal device via the first access point, a second setting for allowing the communication apparatus to execute the change processing after the connection between the communication apparatus and the first access point is established.
